(19) United States
(12) Patent Application Publication
(10) Pub. No.: US 2026/0131278 A1
(43) Pub. Date: May 14, 2026

(54) Low-Energy CO2 Capture and Separation

(71) Applicant: NRGTEK, Inc., Orange, CA (US)

(72) Inventor: Subramanian Iyer, Yorba Linda, CA (US)

(73) Assignee: NRGTEK, Inc., Orange, CA (US)

(21) Appl. No.: 18/944,445

(22) Filed: Nov. 12, 2024

(51) Int. Cl. B01D 53/14; B01D 61/00

(52) U.S. Cl. CPC B01D 53/1493; B01D 53/1425; B01D 53/1475; B01D 61/002; B01D 2252/20415; B01D 2252/20421; B01D 2252/20426

(57) ABSTRACT

A method of absorbing CO₂ from a gas stream is contemplated where the gas stream is directed into contact with at least one multi-amine molecular solvent liquid stream, thus drawing at least some of the CO₂ out of the gas stream to create a CO₂ -reduced gas stream and a CO₂ -rich solvent liquid stream, the CO₂-reduced gas stream is then separated from the CO₂-rich solvent liquid stream, and the CO₂ is separated from the CO₂ -rich solvent liquid stream so that the solvent can be recycled for use again in CO₂ absorption. Reduction in energy consumption during solvent regeneration and CO₂ separation is done by phase separation or forward osmosis processes.

### BACKGROUND

Carbon dioxide emissions from various industrial activities are a major concern for greenhouse gas emissions and climate change scenarios. There are various processes employed, therefore, for the removal of CO₂ before discharge to the atmosphere. Carbon capture and storage (CCS) is a process in which a stream of carbon dioxide (CO₂) from industrial sources or ambient air is separated, treated and transported to a long-term storage location. In CCS, the CO₂ is typically captured from a large point source, such as a coal-fired power plant, a natural gas power plant, or natural gas processing plants, and is often stored in deep geological formations. In many cases, the CO₂ captured is used for enhanced oil recovery (EOR), a process in which CO₂ is injected into partially depleted oil reservoirs to extract more oil and then is left underground. Since EOR utilizes CO₂ in addition to storing it, CCS is also known as carbon capture, utilization, and storage (CCUS).

Several methods are available for removal of acid gases from product gas streams. Some of the more commonly used methods are chemical solvents, physical solvents, membranes, and cryogenic fractionation. CO₂, an acid gas, can be absorbed by many basic chemical solvents, including alkali hydroxides/carbonates, aqueous ammonia, and alkanolamines. Ethanolamines (MEA, DEA, MDEA, DGA, etc.) are chemical solvent processes that rely on chemical reactions to remove acid gas constituents from sour gas streams. One issue is regenerating the sorbents. The binding between sorbent molecules and CO₂ generally is strong and this offers a fast and effective removal of most of CO₂ in one stage of absorption. Ideally, a mole of amine can absorb one mole of carbon dioxide. However, the strong binding between CO₂ and the sorbent molecules is also one of the causes for high energy requirement for solvent regeneration.

Chemical solvents like alkanolamines, are usually used as aqueous solutions, either by themselves or as mixtures, and with or without catalysts (like piperazine, PZ). Monoethanolamine (MEA) is used as a 15-20% solution in water; diethanolamine (DEA) as a 20-30% solution in water, and N-methyl diethanolamine (MDEA) as a 30-50% solution in water.

A major limitation of using MEA as a sorbent is its low amount of CO₂ absorption, only 43.8 mg CO₂/g of solvent, as reported in literature (e.g., R. Notz, N. Asprion, I. Clausen and H. Hasse, Chem. Eng. Res. Des., 2007, 85(A4), 510–515 and A.B. Rao and E.S. Rubin, Environ. Sci. Technol., 2002, 36, 4467–4475). DEA and MDEA have even lower CO₂ absorption capacities. Another limitation is MEA’s high heat of absorption for CO₂ (72 KJ/mole), equivalent to 18% of the combustion heat of carbon (393.5 KJ/mole). The total regeneration energy required is about 900 kcal/kg CO₂, or 165 KJ/mole CO₂, equivalent to 42% heat from burning a mole of carbon, and 25% of the total combustion energy generated by burning coal. Although the stripper uses low-grade steam, it still causes almost a 20% reduction in power generation for a coal-fired power plant, if all the CO₂ in the flue gas must be removed and sequestered. If a cost-effective low-energy pathway can be used to desorb CO₂ and regenerate the amines, the extraction of CO₂ from low-pressure raw gas streams would be more economically viable. The same limitation is true for DEA and MDEA. Higher absorption capacity amines are needed for large-scale industrial carbon dioxide capture.

### SUMMARY OF THE INVENTION

A new class of solvents, based on multi-amine molecular structures for greater absorption of acid gases, is presented herein, as well as methods to reduce the energy consumption during solvent regeneration. It is proposed that, for example, diamines, triamines, tetraamines and pentaamines, either linear or branched, and comprising primary, secondary and/or tertiary amines in their molecular structure, have a higher CO₂ absorption rate and the absorbed CO₂ can be desorbed at lower energy consumption than traditional amines, using process systems described.

In one embodiment, a method of absorbing CO₂ from a gas stream comprises directing the gas stream into contact with at least one multi-amine molecular solvent liquid stream, thus drawing at least some of the CO₂ out of the gas stream to create a CO₂ -reduced gas stream and a CO₂ -rich solvent liquid stream. It is contemplated that one embodiment of a present method further comprises separating the CO₂ -reduced gas stream from the CO₂ -rich solvent liquid stream, and preferably separating the CO₂ from the CO₂ -rich solvent liquid stream so that the solvent can be recycled for use again in CO₂ absorption. In one embodiment, a method comprises removing at least some water from the CO₂-rich solvent prior to separating the CO₂ from the solvent, using, for example, a phase separation process, a forward osmosis process, and/or both to create a water-rich stream and a solvent-rich stream.

### BRIEF DESCRIPTION OF FIGURES

The accompanying drawings, which are incorporated in and constitute a part of this specification, illustrate aspects of the disclosed subject matter in at least one of its exemplary embodiments, which are further defined in detail in the following description. Features, elements, and aspects of the disclosure are referenced by numerals with like numerals in different drawings representing the same, equivalent, or similar features, elements, or aspects, in accordance with one or more embodiments. The drawings are not necessarily to scale, emphasis instead being placed upon illustrating the principles herein described and provided by exemplary embodiments of the invention. More generally, those skilled in the art will appreciate that the drawings are schematic in nature and are not to be taken literally or to scale in terms of material configurations, sizes, thicknesses, and other attributes of an apparatus according to aspects of the present invention and its components or features unless specifically set forth herein. In such drawings:

FIG. 1 is an example flow diagram for CO₂ separation using phase transfer absorbents;

FIG. 2 is an example flow diagram for CO₂ separation using forward osmosis; and

FIG. 3 is an example flow diagram for CO₂ separation using combined phase separation and forward osmosis processes.

### DETAILED DESCRIPTION

It is proposed that multi-amine molecular structures, such as diamines, triamines and tetraamines, either linear or branched, and comprising primary, secondary or tertiary amines in their molecular structure, have higher CO₂ absorption capacity, as compared to traditional amine-based solvents, at comparable or higher kinetics. These amines have higher boiling points and lower vapor pressures than traditional amines, leading to lesser losses during desorption operations. Use of these amines would result in higher CO₂ absorption metrics.

If these multi-amine molecular structures are used for CO₂ absorption, and, additionally, phase separate from water after CO₂ absorption, the water-rich portion can be removed, and only the amine-rich portion needs to be heated up to thermally desorb the absorbed CO₂ gas. In comparison to conventional amines, after the water has been separated out by decantation or filtration techniques, desorption of the absorbed gas from these amine-terminated amines, occurs at a lower thermal energy consumption. After the desorption is complete, the water-rich phase and the CO₂-poor polymer phase can be remixed and recycled back to the CO₂ absorption process. Such a system would be much more energy-efficient, and would save on operating costs and capital costs for the system. The high boiling points and very low vapor pressures of these multi-amine molecular structures, and their comparative chemical stability, also result in less solvent degradation and losses from volatilization.

Types of multi-amine molecular structures tested included diethylenetriamine (DETA), a branched amine comprising both primary and secondary amines. Thus, when testing a 50% DETA solution in water, CO₂ absorption was observed to be around 739.799 mg CO₂ per ml of DETA. Using a lower concentration solution of DETA, approximately 30%, CO₂ absorption was observed to be around 454.88 mg CO₂ per ml of DETA.

Several new observations were made during these experiments. Using 50% DETA aqueous solutions, after CO₂ absorption, CO₂ absorption was observed to be around 739.799 mg CO₂ per ml of DETA, AND the solvent separated into a two-phase, clearly separated layered system. The CO₂-rich DETA solvent phase separated from its water solution into a hydrophobic CO₂-rich, solvent-rich section, while the balance of the solution separated into a hydrophilic water-rich section. A 50 ml solution of a 50% DETA solution in water, after CO₂ absorption, phase-separated into a 35 ml DETA-rich solution, and a 15 ml water-rich separated phase. It is assumed that the higher concentrations of DETA resulted in carbonate ions being chemically absorbed by the amine, resulting in exhibition of hydrophobicity. It is assumed that all the CO₂ absorbed is in the DETA-rich phase. Using suitable separation processes to separate immiscible liquids, like liquid-liquid coalescers, the now-separated water-lean, CO₂-rich DETA portion can be used to desorb CO₂ by application of heat at a lowered energy consumption than traditional amine-based CO₂ absorption solvents, resulting in an energy savings of 20-30% as compared to traditional amines like MEA, DEA or MDEA for solvent regeneration and continued CO₂-absorption cycling.

The above-described process of phase separation after gas absorption has important implications for practical use of these chemicals, and major advantages in energy consumption for regeneration of these solvents, in comparison to traditional amines like MEA, DEA and MDEA used for acid gas absorption. MEA is used as a 20-25% solution in water, while DEA is used as a 30-35% solution in water, and MDEA is used as a 30-50% solution in water. During regeneration of these chemical solvents, typically done at 120-135^{o}C, even the water is vaporized while desorbing the absorbed gas, and at 540 kcal/liter, is a substantial energy penalty for regeneration of the solvent, while also increasing the complexity of the processing and heat exchangers involved.

Another test involved using 30% DETA solutions in water for CO₂ absorption, resulting in CO₂ absorption of around 454.88 mg CO₂ per ml of DETA. Since no phase separation was observed after absorption, it is assumed that the CO₂ was chemically absorbed by the amines as bicarbonate ions, which are more soluble in water than carbonate ions. A test comprising forward osmosis was devised to remove some of the water content of the CO₂-rich solvent.

Forward osmosis (FO) is a process technology being explored for desalination of seawater, as well as treatment of industrial wastewater and other saline waters. Unlike reverse osmosis (RO) processes, which employ high pressures ranging from 400-1100 psi to drive fresh water through the membrane, forward osmosis uses the natural osmotic pressures of solutions to effect freshwater separation. A draw solution having a significantly higher osmotic pressure than the feedwater flows along the permeate side of the membrane, and water naturally transports itself across the membrane by osmosis due to osmotic pressure gradients. Osmotic driving forces in FO can be significantly greater than hydraulic driving forces in RO, leading to higher water flux rates and recoveries. Thus, it is a non-pressurized system, allowing design with lighter, compact systems, using less expensive materials and low-pressure pumps. These factors translate into savings both in capital and operational costs. The osmotic potential differential of a CO₂-rich 30% DETA aqueous solution, as compared to a 70% DETA aqueous solution in water (the draw solution), is almost 185 atmospheres, giving a significant osmotic pressure gradient for water transfer across a semi-permeable membrane.

Using a draw solution comprising 70% DETA in water as the draw solution across a semi-permeable membrane, against a CO₂-rich 30% DETA solvent feed solution, around 35% of the water was drawn from the feed solution. The CO₂-rich solvent solution was concentrated to a 53.85% solution, while the 70% draw solution is diluted down to a 53.85% solution, equalizing the osmotic potentials of the solutions across the semi-permeable membrane. The removal of water from the 30% DETA solution, after CO₂ absorption, as subjected to a forward osmosis system, resulted in a concentrated CO₂-rich solution, which can be subjected to lower thermal energy requirements for solvent regeneration and CO₂ desorption, as compared to traditional amine-based solvent systems.

Other suitable amine-based chemical absorbents include triethylenetetramine (TETA), or various diamines on a polyethylene or polypropylene glycol backbone. Some of the latter polyetheramines are more reactive due to the unhindered nature of the amine groups. Testing EDR-148, an unhindered primary diamine from Huntsman Chemicals, in a 50% aqueous solution, CO₂ absorption was observed to be around 173.25 mg CO₂ per ml of EDR-148. These CO₂ absorption results are much higher than conventional amines used in carbon dioxide capture and separation in industry. While no phase separation after CO₂ absorption was observed, use of forward osmosis processes across different concentrations of these amines in aqueous solutions can result in significant energy savings for CO₂ desorption and solvent regeneration.

Examples of processes of reduced energy consumption for CO₂ separation and solvent regeneration are provided. Using high concentration amine solvents (preferably DETA at ≥ 50% v/v in water) it was observed, after CO₂ absorption, that a two-layer liquid system was formed at room temperature and ambient pressure: one layer was solvent-rich, and the other layer was water-rich. Given the known propensity of minimal CO₂ solubility in water at neutral pH, it can safely be assumed that most of the carbon dioxide was absorbed by the multi-amine molecules as carbonate ions.

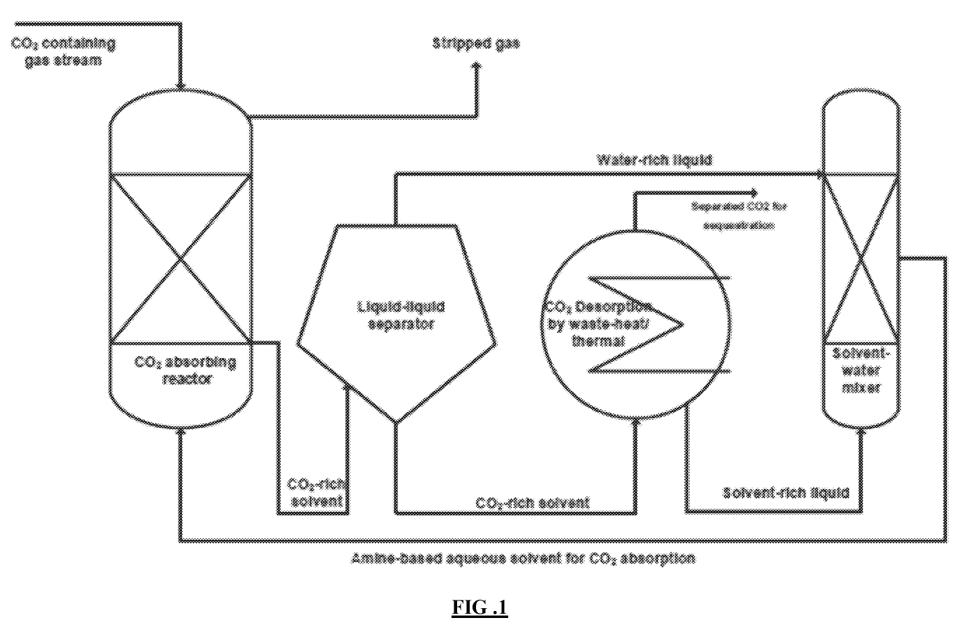

Referring to FIG. 1, a flow diagram for utilizing this observation for reduced energy consumption for CO₂ separation and solvent regeneration is shown. In this example embodiment, the absorption of carbon dioxide from a CO₂-rich gas stream is done in a high-concentration amine-rich stream, preferably constituting the amines described earlier. A biphasic mixture after CO₂ was observed. The resultant biphasic mixture is then directed to a liquid-liquid separator system, wherein the two phases are physically separated into a solvent-rich water-poor CO₂-rich portion, and a water-rich portion. The water-poor, solvent-CO₂-rich stream is subsequently directed to a heat exchanger, wherein the CO₂ is desorbed by application of thermal heat, at a lower heat expense than traditional amines. After CO₂ desorption, the water-rich stream and the water-poor, solvent-rich stream are mixed together and reused for continued CO₂ absorption and desorption cycles. The separation of the two streams, prior to CO₂ desorption, is expected to contribute around 20-30% in thermal energy savings for solvent regeneration and recycling for continued CO₂ absorption. In addition, the high boiling points and low vapor pressure of the described amine polymers enable much lower operating and capital costs for carbon dioxide capture.

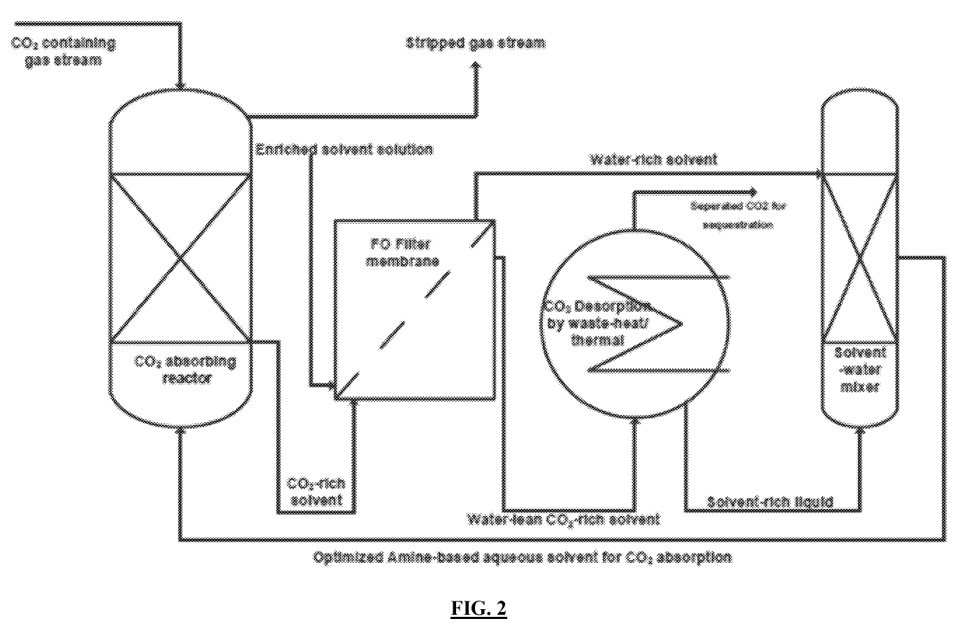

Using lower concentration amine solvents (preferably DETA at 35-450% v/v in water), it was observed, after CO₂ absorption, that no two-layer liquid system was formed at room temperature and ambient pressure. Given the known propensity of minimal CO₂ solubility in water as carbonate ions at neutral pH, it can safely be assumed that most of the carbon dioxide was absorbed by the amine molecules as bicarbonate ions in the excess water, which are much more soluble in water solutions. Referring to FIG. 2, an alternative example embodiment for removing water from the CO₂-rich amine solution is shown, in which at least one step comprises using a forward osmosis process. The absorption of carbon dioxide from a CO₂-rich gas stream was done in a medium-concentration amine-rich stream, preferably constituting the multi-amines described earlier. The resultant mixture is then directed to a forward osmosis system, wherein the CO₂-rich solvent solution is directed into the feed side of a forward-osmosis membrane system, against a solution comprising a higher concentration of the same multi-amine solvent, termed as the draw side. Water is absorbed from the feed-side CO₂-rich solvent into the draw-side solvent-rich solution across a semi-permeable membrane, resulting in a water-lean, CO₂-rich solvent. The water-lean, CO₂-rich solvent is then preferentially directed to a heat exchanger to desorb the absorbed CO₂, resulting in a water-lean, CO₂-lean solvent. After CO₂ desorption, the water-rich and the water-poor solvent-rich streams are mixed and reused for continued CO₂ absorption and desorption cycles. The separation of the two streams, prior to CO₂ desorption, is expected to contribute around 20-30% in thermal energy savings for solvent regeneration and recycling for continued CO₂ absorption. In addition, the high boiling points and low vapor pressure of the described amine polymers enable lower operating and capital costs for carbon capture.

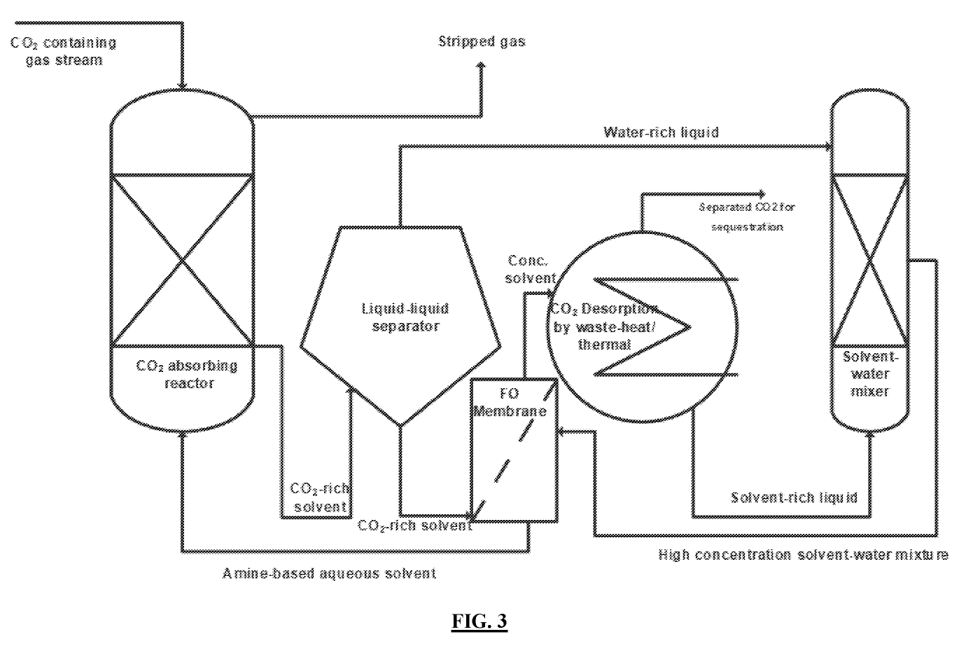

Referring to FIG. 3, yet another example embodiment is shown for reducing the water content of the CO₂-rich aqueous amine solvent, which will result in higher energy savings for CO₂ desorption and solvent regeneration. The absorption of carbon dioxide from a CO₂-rich gas stream is done in a high-concentration amine-rich stream, preferably constituting the multi-amines described earlier, preferably at a concentration of 50% v/v. The resultant biphasic mixture is then directed to a liquid-liquid separator system, wherein the two phases are physically separated into a solvent-CO₂-rich stream and a water-rich stream. The solvent-CO₂-rich stream is subsequently directed to a forward osmosis system, wherein more water is removed, using draw solutions comprising 75-85% amines in water. The water-poor, CO₂-rich solvent stream is directed to a heat exchanger, wherein the CO₂ is desorbed by application of thermal heat, at a lower heat expense than traditional amines. After CO₂ desorption, the water-rich and the water-poor, solvent-rich streams are mixed and reused for continued CO₂ absorption and desorption cycles.

The separation of the two streams, prior to CO₂ desorption, is expected to contribute around 30-40% in thermal energy savings for solvent regeneration and recycling for continued CO₂ absorption. In addition, the high boiling points and low vapor pressure of the described amine polymers enable much lower operating and capital costs for carbon capture.

It is proposed that multi-amine molecular structures, such as diamines, triamines and tetraamines, either linear or branched, and comprising primary, secondary or tertiary amines in their molecular structure, have higher CO₂ absorption capacity, as compared to traditional amine-based solvents, at comparable or higher kinetics. These amines have higher boiling points and lower vapor pressures than traditional amines, leading to lesser losses during desorption operations. Use of phase separation properties of these solvents and/or forward osmosis processes results in lower energy consumption for CO₂ absorption and separation.

In closing, foregoing descriptions of embodiments of the present invention have been presented for the purposes of illustration and description. It is to be understood that, although aspects of the present invention are highlighted by referring to specific embodiments, one skilled in the art will readily appreciate that these described embodiments are only illustrative of the principles comprising the present invention and such examples are not limiting thereto. As such, the specific embodiments are not intended to be exhaustive or to limit the invention to the precise forms disclosed. The use of any and all examples or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

In addition, groupings of alternative embodiments, elements, steps and/or limitations of the present invention are not to be construed as limitations. Each such grouping may be referred to and claimed individually or in any combination with other groupings disclosed herein. It is anticipated that one or more alternative embodiments, elements, steps and/or limitations of a grouping may be included in, or deleted from, the grouping for reasons of convenience and/or patentability. When any such inclusion or deletion occurs, the specification is deemed to contain the grouping as modified, thus fulfilling the written description of all Markush groups used in the appended claims. In addition, all methods described herein can be performed in any suitable order unless otherwise indicated herein or otherwise clearly contradicted by context. Therefore, it should be understood that embodiments of the disclosed subject matter are in no way limited to a particular element, compound, composition, component, article, apparatus, methodology, use, protocol, step, and/or limitation described herein, unless expressly stated as such.

While aspects of the inventive subject matter have been described with reference to at least one exemplary embodiment, it is to be clearly understood by those skilled in the art that the inventive subject matter is not limited thereto. For example, although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed. Furthermore, those of ordinary skill in the art will recognize that certain changes, modifications, permutations, alterations, additions, subtractions, and sub-combinations thereof can be made in accordance with the teachings herein without departing from the spirit of the present inventive subject matter. Thus, while the inventive subject matter is susceptible of various modifications and alternative embodiments, certain illustrated embodiments thereof are shown in the drawings and will be described below in detail. It should be understood, however, that there is no intention to limit the inventive subject matter to any specific form disclosed, but on the contrary, the inventive subject matter is to cover all modifications, alternative embodiments, and equivalents falling within the scope of the claims. It is intended that the following appended claims and claims hereafter introduced are interpreted to include all such changes, modifications, permutations, alterations, additions, subtractions, and sub-combinations as are within their true spirit and scope. Accordingly, the scope of the present inventive subject matter is not to be limited to that precisely as shown and described by this specification. Rather, the scope of the inventive subject matter is to be interpreted only in conjunction with the appended claims and it is made clear, here, that the inventor(s) believe that the claimed subject matter is the inventive subject matter.

Certain embodiments of the present inventive subject matter are described herein, including the best mode known to the inventors for conducting the inventive subject matter. Of course, variations on these described embodiments will become apparent to those of ordinary skill in the art upon reading the foregoing description. The inventor expects skilled artisans to employ such variations as appropriate, and the inventors intend for the present inventive subject matter to be practiced otherwise than specifically described herein. Accordingly, this inventive subject matter includes all modifications and equivalents of the subject matter recited in the claims appended hereto as permitted by applicable law. Moreover, any combination of the above-described embodiments in all possible variations thereof is encompassed by the inventive subject matter unless otherwise indicated herein or otherwise clearly contradicted by context.

The words, language, and terminology used in this specification is for the purpose of describing particular embodiments, elements, steps and/or limitations only and is not intended to limit the scope of the present inventive subject matter, which is defined solely by the claims. In addition, such words, language, and terminology are to be understood not only in the sense of their commonly defined meanings, but to include by special definition in this specification structure, material or acts beyond the scope of the commonly defined meanings. Thus, if an element, step or limitation can be understood in the context of this specification as including more than one meaning, then its use in a claim must be understood as being generic to all possible meanings supported by the specification and by the word itself.

The definitions and meanings of the elements, steps or limitations recited in a claim set forth below are, therefore, defined in this specification to include not only the combination of elements, steps or limitations which are literally set forth, but all equivalent structure, material or acts for performing substantially the same function in substantially the same way to obtain substantially the same result. In this sense it is therefore contemplated that an equivalent substitution of two or more elements, steps and/or limitations may be made for any one of the elements, steps or limitations in a claim set forth below or that a single element, step, or limitation may be substituted for two or more elements, steps and/or limitations in such a claim. Although elements, steps or limitations may be described above as acting in certain combinations and even initially claimed as such, it is to be expressly understood that one or more elements, steps and/or limitations from a claimed combination can in some cases be excised from the combination and that the claimed combination may be directed to a sub-combination or variation of a sub-combination. As such, notwithstanding the fact that the elements, steps and/or limitations of a claim are set forth below in a certain combination, it must be expressly understood that the inventive subject matter includes other combinations of fewer, more, or different elements, steps and/or limitations, which are disclosed in above combination even when not initially claimed in such combinations. Furthermore, insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. Accordingly, the claims are thus to be understood to include what is specifically illustrated and described above, what is conceptually equivalent, what can be obviously substituted and also what essentially incorporates the essential idea of the inventive subject matter.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the inventive subject matter are approximations, the numerical ranges and values set forth in the specific examples are reported as precisely as possible. Any numerical range or value, however, inherently contains certain errors necessarily resulting from the standard deviation found in their respective testing measurements. Unless the context dictates the contrary, all ranges set forth herein should be interpreted as being inclusive of their endpoints and open-ended ranges should be interpreted to include only commercially practical values. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, all lists of values should be considered as inclusive of intermediate values unless the context indicates the contrary.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a comparable manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present inventive subject matter (especially in the context of the following claims) are to be construed to cover both the singular and the plural, unless otherwise indicated herein or clearly contradicted by context. Further, ordinal indicators – such as, e.g., “first,” “second,” “third,” etc. – for identified elements are used to distinguish between the elements, and do not indicate or imply a required or limited number of such elements, and do not indicate a particular position or order of such elements unless otherwise specifically stated.

When used in the claims, whether as filed or added per amendment, the open-ended transitional term “comprising”, variations thereof such as, e.g., “comprise” and “comprises”, and equivalent open-ended transitional phrases thereof like “including”, “containing” and “having”, encompass all the expressly recited elements, limitations, steps, integers, and/or features alone or in combination with unrecited subject matter; the named elements, limitations, steps, integers, and/or features are essential, but other unnamed elements, limitations, steps, integers, and/or features may be added and still form a construct within the scope of the claim. Specific embodiments disclosed herein may be further limited in the claims using the closed-ended transitional phrases “consisting of” or “consisting essentially of” (or variations thereof such as, e.g., “consist of”, “consists of”, “consist essentially of”, and “consists essentially of”) in lieu of or as an amendment for “comprising.” When used in the claims, whether as filed or added per amendment, the closed-ended transitional phrase “consisting of” excludes any element, limitation, step, integer, or feature not expressly recited in the claims. The closed-ended transitional phrase “consisting essentially of” limits the scope of a claim to the expressly recited elements, limitations, steps, integers, and/or features and any other elements, limitations, steps, integers, and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps, integers, and/or features specifically recited in the claim, whereas the meaning of the closed-ended transitional phrase “consisting essentially of” is being defined as only including those elements, limitations, steps, integers, and/or features specifically recited in the claim and those elements, limitations, steps, integers, and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such, the embodiments described herein or so claimed with the phrase “comprising” expressly and unambiguously provide description, enablement, and support for the phrases “consisting essentially of” and “consisting of.”

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C …. and N, the text should be interpreted as requiring only one element from the group, not A plus N, or B plus N, etc.

Any claims intended to be treated under 35 U.S.C. §112(f) will begin with the words “means for,” but use of the term “for” in any other context is not intended to invoke treatment under 35 U.S.C. §112(f). Accordingly, Applicant reserves the right to pursue additional claims after filing this application, in either this application or in a continuing application.

It should be understood that the methods and the order in which the respective elements of each method are performed are purely exemplary. Depending on the implementation, they may be performed in any order or in parallel, unless indicated otherwise in the present disclosure.

Finally, all patents, patent publications, and other references cited and identified in the present specification are individually and expressly incorporated herein by reference in their entirety to the same extent as if each individual publication or patent application were specifically and individually indicated to be incorporated by reference. These publications are provided solely for their disclosure prior to the filing date of the present application. The reference to any prior art in this specification is not, and should not be taken as, an acknowledgement or any form of suggestion that the prior art forms part of the common general knowledge from any country. In addition, where a definition or use of a term in an incorporated reference is inconsistent or contrary to the definition of that term provided herein, the definition of that term provided herein applies and the definition of that term in the reference does not apply. Lastly, nothing in this regard is or should be construed as an admission that the inventors are not entitled to antedate such disclosure by virtue of prior invention or for any other reason. All statements as to the date or representation as to the contents of these documents are based on the information available to the applicant and do not constitute any admission as to the correctness of the dates or contents of these documents.

1. A method of absorbing CO₂ from a gas stream, the method comprising directing the gas stream into contact with at least one multi-amine molecular solvent liquid stream, thus drawing at least some of the CO₂ out of the gas stream to create a CO₂-reduced gas stream and a CO₂-rich solvent liquid stream.

2. The method of claim 1, further comprising separating the CO₂-reduced gas stream from the CO₂-rich solvent liquid stream.

3. The method of claim 2, further comprising separating the CO₂ from the CO₂-rich solvent liquid stream so that the solvent can be recycled for use again in CO₂ absorption.

4. The method of claim 3, further comprising removing at least some water from the CO₂-rich solvent prior to separating the CO₂ from the solvent.

5. The method of claim 4, wherein the water removal comprises using a phase separation process to create a water-rich stream and a solvent-rich stream.

6. The method of claim 4, wherein the water removal comprises using a forward osmosis process to create a water-rich stream and a solvent-rich stream.

7. The method of claim 4, wherein the water removal comprises using both a phase separation and a forward osmosis process to create a water-rich stream and a solvent-rich stream.
